(19) United States
(12) Patent Application Publication
(10) Pub. No.: US 2019/0168351 A1
(43) Pub. Date: Jun. 6, 2019

(54) METHOD FOR MANUFACTURING RING AND RING POLISHING APPARATUS

(71) Applicant: AISIN AW CO., LTD., Anjo-shi, Aichi-ken (JP)

(72) Inventors: Takashi OBAYASHI, Anjo (JP); Yohei ITO, Anjo-shi, Aichi-ken (JP)

(73) Assignee: AISIN AW CO., LTD., Anjo-shi, Aichi-ken (JP)

(21) Appl. No.: 16/321,505

(22) PCT Filed: Sep. 28, 2017
(86) PCT No.: PCT/JP2017/035127

§ 371 Date: Jan. 29, 2019

(30) Foreign Application Priority Data
Sep. 30, 2016 (JP) 2016-193487

(51) Int. Cl. B24B 9/04; F16G 5/16; B24B 41/02; B24B 27/00

(52) U.S. Cl. CPC B24B 9/04; F16G 5/16; B24B 41/066; B24B 27/0076; B24B 41/02

(57) ABSTRACT

Provided is a method for manufacturing an endless metal ring for a continuously variable transmission using a transmission belt formed by binding a plurality of elements with the ring. A tubular body is cut into a plurality of ring bodies, and under tension, the ring body is rotated in a circumferential direction, and a grinding wheel is pressed against a lateral end of the ring body from an outer toward an inner peripheral side of the ring body to remove an edge portion on the outer peripheral side of the lateral end of the ring body formed by the cutting, and a grinding wheel is pressed against the lateral end of the ring body from the inner toward the outer peripheral side of the ring body to remove an edge portion on the inner peripheral side of the lateral end of the ring body formed by the cutting.

### CROSS REFERENCE TO RELATED APPLICATIONS

This application is a National Stage of International Application No. PCT/JP2017/035127, filed Sep. 28, 2017, claiming priority based on Japanese Patent Application No. 2016-193487, filed Sep. 30, 2016.

### TECHNICAL FIELD

Aspects of the present disclosure relate to methods for manufacturing a ring and ring polishing apparatuses.

### BACKGROUND ART

Conventionally, methods using barrel polishing are known as methods for processing the lateral ends of a ring in a belt-type continuously variable transmission. In barrel polishing, auxiliary materials such as abrasive are expensive. Moreover, since the inner and outer peripheral surfaces of a ring are also polished, fine scratches are made on the surfaces, which may adversely affect fatigue strength. An alternative method to barrel polishing has been proposed in which a ring wound around a tension roll and a return roll and under tension is rotated in the circumferential direction, and end face processing rolls (grinding wheels), each having in its peripheral surface a groove with a radius of curvature R satisfying the relationship R≥t/2 for the thickness t of the ring, are pressed against both lateral ends of the ring to process the lateral ends of the ring into a round shape (see, e.g., Patent Document 1).

Patent Document 1: Japanese Patent Application Publication No. 2002-248522 (JP 2002-248522 A)

### SUMMARY

In the technique of Patent Document 1, sufficient processing accuracy can be achieved if there is no variation in thickness of rings to be processed. However, there is actually a variation in thickness of the rings. Accordingly, if the grooves in the end face processing rolls (grinding wheels) have a fixed shape (radius of curvature), processing accuracy is reduced. For example, edges remain on the end faces of the ring.

It is an aspect of the present disclosure to achieve accurate processing of lateral ends of a ring regardless of a variation in thickness of rings.

It is an aspect of the present disclosure to achieve accurate processing of lateral ends of a ring regardless of a variation in thickness of rings.

A method for manufacturing a ring according to the present disclosure is a method for manufacturing an endless metal ring for a continuously variable transmission using a transmission belt that is formed by binding a plurality of elements with the ring. In the method, after a tubular body formed by butt welding ends of a strip is cut into a plurality of ring bodies, the ring body being under tension is rotated in a circumferential direction, and a grinding wheel is pressed against a lateral end of the ring body from an outer peripheral side toward an inner peripheral side in a thickness direction of the ring body to remove an edge portion which is on the outer peripheral side of the lateral end of the ring body and has been formed by the cutting, and a grinding wheel is pressed against the lateral end of the ring body from the inner peripheral side toward the outer peripheral side in the thickness direction of the ring body to remove an edge portion which is on the inner peripheral side of the lateral end of the ring body and has been formed by the cutting.

In the method for manufacturing a ring according to the present disclosure, after a tubular body formed by butt welding ends of a strip is cut into a plurality of ring bodies, the ring body being under tension is rotated in the circumferential direction, and the grinding wheel is pressed against a lateral end of the ring body from the outer peripheral side toward the inner peripheral side to remove an edge portion which is on the outer peripheral side of the lateral end of the ring body and has been formed by the cutting, and the grinding wheel is pressed against the lateral end of the ring body from the inner peripheral side toward the outer peripheral side to remove an edge portion which is on the inner peripheral side of the lateral end of the ring body and has been formed by the cutting. The outer peripheral side and the inner peripheral side of the lateral end of the ring body are thus separately processed (edge removal). Accordingly, processing accuracy of the lateral end of the ring body can be improved even if there is a variation in thickness of the ring bodies.

A first ring polishing apparatus according to the present disclosure is a ring polishing apparatus for polishing into a convex arc shape (round shape) a lateral end of an endless metal ring for a continuously variable transmission using a transmission belt that is formed by binding elements with the ring. The apparatus includes: a rotating unit that has a first roller and a second roller and that rotates the ring wound around the first roller and the second roller and under tension in a circumferential direction; a first polishing unit that has a concave arc-shaped first polishing portion and that presses the first polishing portion against the lateral end of the ring from an outer peripheral side toward an inner peripheral side in a thickness direction of the ring to polish the outer peripheral side of the lateral end of the ring into a round shape; and a second polishing unit that has a concave arc-shaped second polishing portion and that presses the second polishing portion against the lateral end of the ring from the inner peripheral side toward the outer peripheral side in the thickness direction of the ring to polish the inner peripheral side of the lateral end of the ring into a round shape.

In the first ring polishing apparatus according to the present disclosure, a polishing unit for polishing a lateral end of the ring into a round shape is divided into the first polishing unit having the concave arc-shaped first polishing portion and the second polishing unit having the concave arc-shaped second polishing portion. The first polishing portion is pressed against the lateral end of the ring from the outer peripheral side toward the inner peripheral side in the thickness direction of the ring to polish the outer peripheral side of the lateral end of the ring into a round shape, and the second polishing portion is pressed against the lateral end of the ring from the inner peripheral side toward the outer peripheral side in the thickness direction of the ring to polish the inner peripheral side of the lateral end of the ring into a round shape. Since the outer peripheral side and the inner peripheral side of the lateral end of the ring are thus separately polished, processing accuracy of the lateral end of the ring can be improved even if there is a variation in thickness of the rings.

A second ring polishing apparatus according to the present disclosure is a ring polishing apparatus for polishing into a round shape a lateral end of an endless metal ring for a continuously variable transmission using a transmission belt that is formed by binding elements with the ring. The apparatus includes: a rotating unit that has a first roller and a second roller and that rotates the ring wound around the first roller and the second roller and under tension in a circumferential direction; and a polishing unit that has a concave arc-shaped first polishing portion and a concave arc-shaped second polishing portion which are formed next to each other in a thickness direction of the ring so that the ring is located between the first polishing portion and the second polishing portion, and that presses the first polishing portion against the lateral end of the ring from an outer peripheral side toward an inner peripheral side in the thickness direction of the ring to polish the outer peripheral side of the lateral end of the ring into a round shape, and presses the second polishing portion against the lateral end of the ring from the inner peripheral side toward the outer peripheral side in the thickness direction of the ring to polish the inner peripheral side of the lateral end of the ring into a round shape.

In the second ring polishing apparatus according to the present disclosure, a polishing unit for polishing a lateral end of the ring into a round shape is the polishing unit having the concave arc-shaped first polishing portion and the concave arc-shaped second polishing portion which are formed next to each other in the thickness direction of the ring so that the ring set on the rotating unit is located between the first polishing portion and the second polishing portion. The first polishing portion is pressed against the lateral end of the ring from the outer peripheral side toward the inner peripheral side in the thickness direction of the ring to polish the outer peripheral side of the lateral end of the ring into a round shape, and the second polishing portion is pressed against the lateral end of the ring from the inner peripheral side toward the outer peripheral side in the thickness direction of the ring to polish the inner peripheral side of the lateral end of the ring into a round shape. The outer peripheral side and the inner peripheral side of the lateral end of the ring are thus separately polished. Accordingly, processing accuracy of the lateral end of the ring can be improved even if there is a variation in thickness of the rings. Moreover, since the outer peripheral side and the inner peripheral side of the lateral end of the ring can be separately polished by the single polishing unit, processing accuracy of the ring can be improved by using a simple configuration.

### BRIEF DESCRIPTION OF THE DRAWINGS

FIG. 1 is a configuration diagram schematically showing the configuration of a continuously variable transmission 1.

FIG. 2 is a configuration diagram schematically showing the configuration of a transmission belt 10.

FIGS. 3A to 3M are illustrations showing an example of a manufacturing process of a ring.

FIG. 4 is a configuration diagram schematically showing the configuration of a polishing apparatus 30.

FIGS. 5A to 5C are illustrations showing how the outer peripheral side of an end of a ring body 23 is rounded by using an outer peripheral-side polishing roll 41.

FIGS. 6A to 6C are illustrations showing how the inner peripheral side of the end of the ring body 23 is rounded by using an inner peripheral-side polishing roll 46.

FIGS. 7A to 7D are illustrations showing how a lateral end of the ring body 23 is rounded by using a polishing roll 41B of a comparative example.

FIG. 8 is a configuration diagram schematically showing the configuration of a polishing apparatus 130 of another embodiment.

FIGS. 9A to 9C are illustrations showing how a lateral end of a ring body 23 is rounded by using a polishing roll 141.

### PREFERRED EMBODIMENTS

Modes for carrying out the various aspects of the present disclosure will be described with reference to the accompanying drawings.

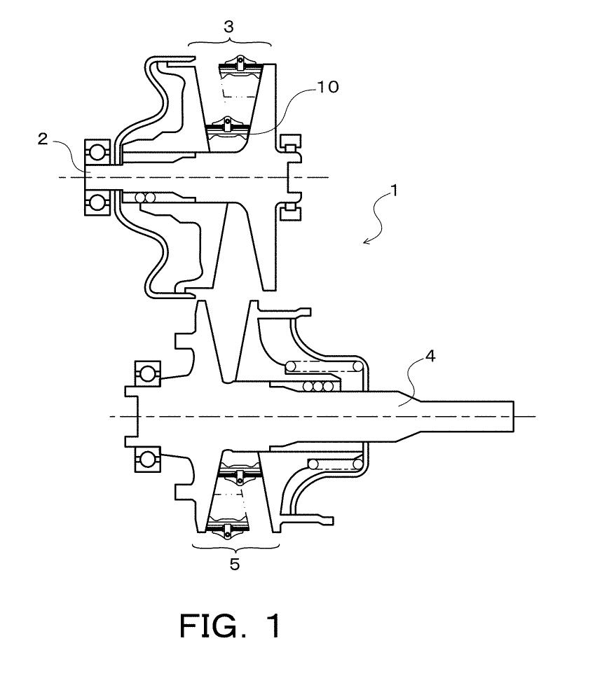

FIG. 1 is a configuration diagram schematically showing the configuration of a continuously variable transmission 1. The continuously variable transmission 1 is mounted on a vehicle including a power source such as an engine, and as shown in the figure, includes a primary shaft 2 serving as a drive-side rotary shaft, a primary pulley 3 provided on the primary shaft 2, a secondary shaft 4 disposed parallel to the primary shaft 2 and serving as a driven-side rotary shaft, a secondary pulley 5 provided on the secondary shaft 4, and a transmission belt 10 wound around a pulley groove (V-groove) of the primary pulley 3 and a pulley groove (V-groove) of the secondary pulley 5. The continuously variable transmission 1 changes the groove widths of the primary pulley 3 and the secondary pulley 5 and thus steplessly shifts power of the primary pulley 3 to transmit the shifted power to the secondary pulley 5.

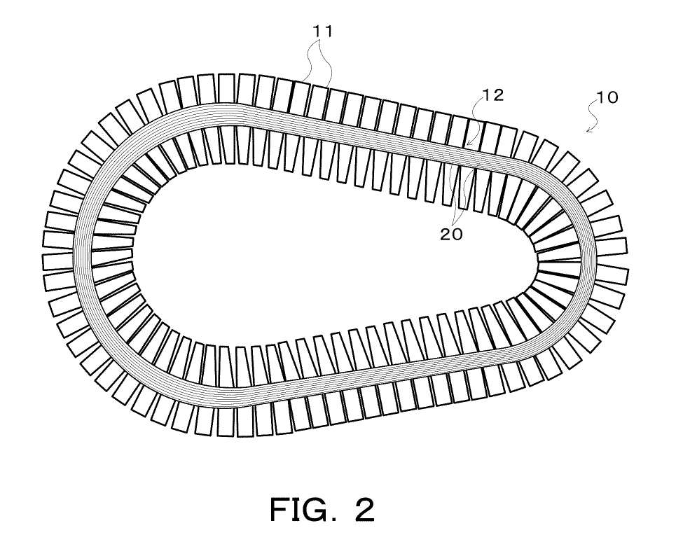

FIG. 2 is a configuration diagram schematically showing the configuration of the transmission belt 10. As shown in FIG. 2, the transmission belt 10 includes a multiple (e.g., several hundreds) elements 11 and a laminated ring 12 and is formed by binding the multiple elements 11 into a ring shape with the laminated ring 12. For example, the elements 11 are parts punched out from a steel sheet by pressing. The elements 11 are subjected to a clamping force from the pulley (the primary pulley 3, the secondary pulley 5) at their right and left side surfaces, and those elements 11 which are located ahead in the traveling direction of the belt are pushed out by the friction force in a direction tangential to the pulley, whereby power is transmitted.

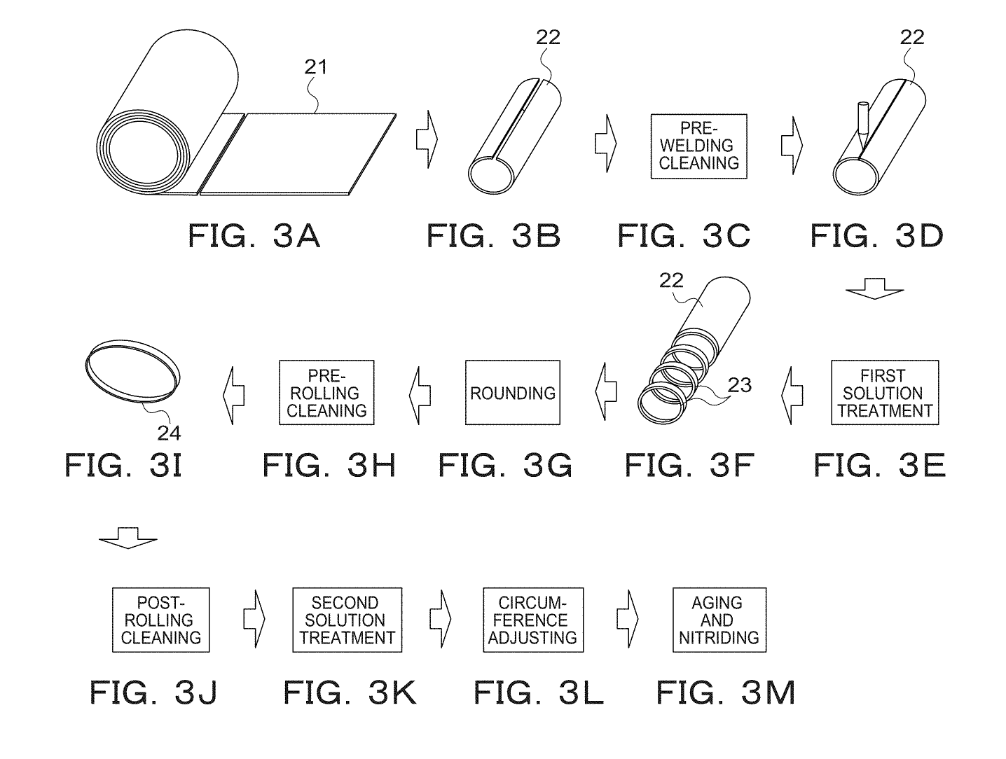

The laminated ring 12 is formed by laminating a plurality of endless metal rings 20 (single rings) having slightly different circumferences from each other in the radial direction. The laminated ring 12 is manufactured by a manufacturing process illustrated in FIGS. 3A to 3M.

The manufacturing process of the ring 20 is comprised of (A) a strip cutting process (see FIG. 3A), (B) a bending process (see FIG. 3B), (C) a pre-welding cleaning process (see FIG. 3C), (D) a welding process (see FIG. 3D), (E) a first solution treatment process (annealing process, see FIG. 3E), (F) a ring cutting process (see FIG. 3F), (G) a rounding process (see FIG. 3G), (H) a pre-rolling cleaning process (see FIG. 3H), (I) a rolling process (see FIG. 3I), (J) a post-rolling cleaning process (see FIG. 3J), (K) a second solution treatment process (see FIG. 3K), (L) a circumference adjusting process (see FIG. 3L), and (M) an aging and nitriding process (see FIG. 3M).

The strip cutting process (A) is a process of cutting a strip steel (maraging steel) having a predetermined thickness (e.g., 0.4 to 0.5 mm) and wound around a drum in the lateral direction into strips 21 with a predetermined size. The strip cutting process can be performed by using a cutter cutting machine having a cutter edge, a laser cutting machine, etc. The bending process (B) is a process of forming a tubular body 22 by bending the strip 21 into a tubular shape such that the ends of the strip 21 abut on each other. The bending process can be performed by using a roll or a die.

The pre-welding cleaning process (C) is a process of degreasing and cleaning the tubular body 22 before welding the abutting portions of the tubular body 22. The pre-welding cleaning process can be performed by, e.g., shower cleaning, ultrasonic cleaning, etc. The welding process (D) is a process of performing butt welding, namely welding the abutting portions of the tubular body 22. The welding process can be performed by, e.g., laser welding, plasma welding, etc. The first solution treatment process (annealing process) (E) is a process that is performed in order to level hardness distribution around the weld, which has been changed by the welding process, to improve ductility.

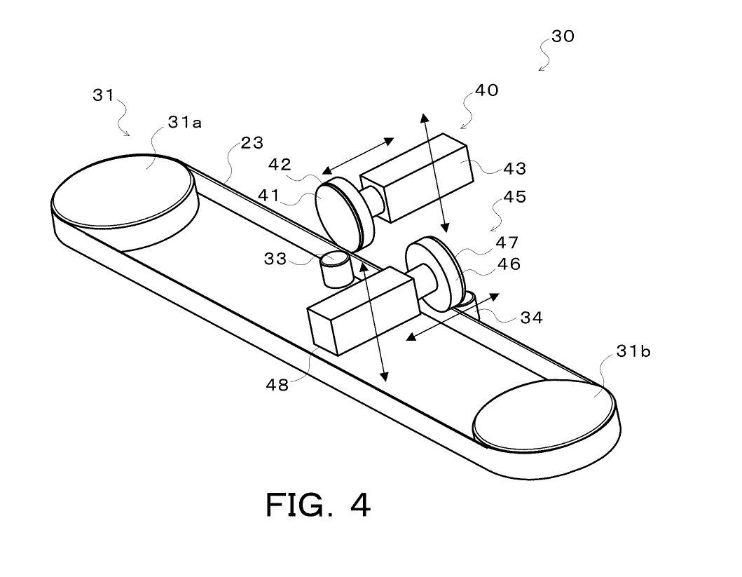

The ring cutting process (F) is a process of cutting the tubular body 22 into a plurality of ring bodies 23 with a predetermined width, and this process can be performed by using a cutter cutting machine, a laser cutting machine, etc. The rounding process (G) is a process of rounding lateral ends of the ring body 23 by polishing with a polishing roll, and this process is performed by using a polishing apparatus 30 illustrated in FIG. 4. As shown in FIG. 4, the polishing apparatus 30 includes: a rotating unit 31 having a drive roller 31a and a driven roller 31b around which the ring body 23 is wound; an inner peripheral-side backup roller 33 that supports the ring body 23 from the inner peripheral side; an outer peripheral-side polishing unit 40 that faces the inner peripheral-side backup roller 33 and polishes the outer peripheral side of a lateral end (the outer peripheral side of an end) of the ring body 23 into a round shape; an outer peripheral-side backup roller 34 that supports the ring body 23 from the outer peripheral side; and an inner peripheral-side polishing unit 45 that faces the outer peripheral-side backup roller 34 and polishes the inner peripheral side of the lateral end (the inner peripheral side of the end) of the ring body 23 into a round shape. The drive roller 31a is pressed against the inner peripheral surface of the ring body 23 in a direction away from the driven roller 31b. The drive roller 31a is driven to rotate, whereby the rotating unit 31 can rotate (turn) the ring body 23 under tension in the circumferential direction. The rotating unit 31 may include a separate tension roller that tensions the ring body 23. The outer peripheral-side polishing unit 40 includes: an outer peripheral-side polishing roll 41 having an axis of rotation extending in a direction parallel to the thickness direction of the ring body 23 set on the rotating unit 31; and a rotating and moving unit 43 capable of rotating and moving the outer peripheral-side polishing roll 41 in the rotational direction of the outer peripheral-side polishing roll 41, the axial direction of the axis of rotation of the outer peripheral-side polishing roll 41 (forward and backward in the figure), and a direction perpendicular to this axial direction and parallel to the lateral direction of the ring body 23 (upward and downward in the figure). The inner peripheral-side polishing unit 45 includes an outer peripheral-side polishing roll 46 and a rotating and rotating unit 48 which are similar to those of the outer peripheral-side polishing unit 40.

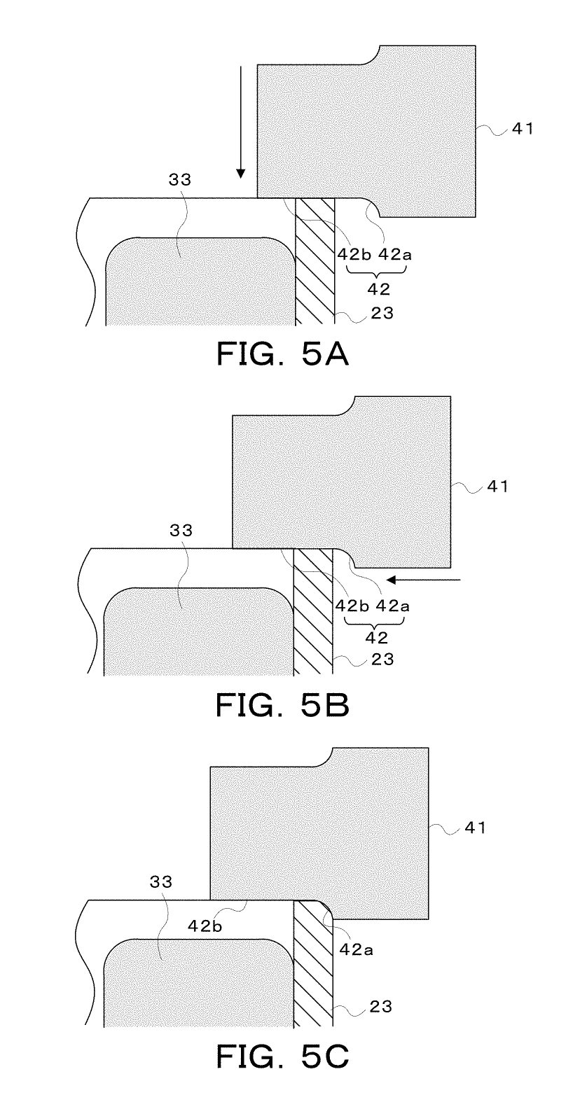

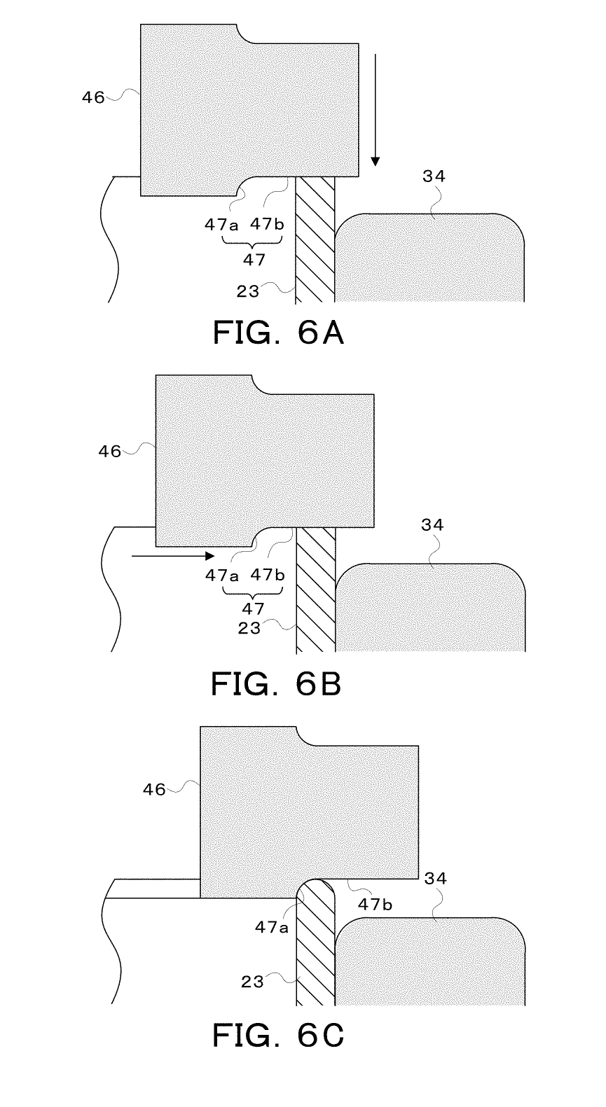

FIGS. 5A to 5C are illustrations showing how the outer peripheral side of an end of the ring body 23 is rounded by using the outer peripheral-side polishing roll 41. FIGS. 6A to 6C are illustrations showing how the inner peripheral side of the end of the ring body 23 is rounded by using the inner peripheral-side polishing roll 46. In FIGS. 5A to 5C and FIGS. 6A to 6C, L-shaped grooves 42, 47 of the outer peripheral-side polishing roll 41 and the inner peripheral-side polishing roll 46 are shown exaggerated for convenience of description. The outer peripheral-side polishing roll 41 and the inner peripheral-side polishing roll 46 are columnar members and have the L-shaped grooves 42, 47 formed in the circumferential direction in the distal end portions of their outer peripheral surfaces along the entire circumference. The bottoms of the L-shaped grooves 42, 47 are formed by linear portions 42b, 47b extending straight in the axial direction of the outer peripheral-side polishing roll 41 and the inner peripheral-side polishing roll 46, and corners of the bottoms of the L-shaped grooves 42, 47 are formed by concave arc-shaped portions 42a, 47a having an arc angle θ of about 90 degrees and a radius of curvature r that is about ½ of the thickness t of the ring body 23. The L-shaped grooves 42, 47 have an abrasive grain layer comprised of abrasive grains bonded together. The ring body 23 is rounded by using the outer peripheral-side polishing roll 41 and the inner peripheral-side polishing roll 46 as follows. First, the outer peripheral-side polishing roll 41 is moved in the lateral direction of the ring body 23 (downward in the figure) while being rotated, and the inner peripheral-side polishing roll 47 is moved in the lateral direction of the ring body 23 (downward in the figure) while being rotated. The linear portions 42b, 47b are thus pressed against the end face of one lateral end of the ring body 23 (see FIGS. 5A, 6A). In the case where a laser cutting machine is used in the ring cutting process (F) described above, each laser cut portion (lateral end) of the ring body 23 has a heat-affected zone that has increased hardness due to structural changes caused by heat. In this case, the heat-affected zone of the ring body 23 can be removed by pressing the linear portions 42b, 47b of the outer peripheral-side polishing roll 41 and the inner peripheral-side polishing roll 46 for the ring body 23 against the end face of the lateral end of the ring body 23 in the rounding process (R). The outer peripheral-side polishing roll 41 is then moved from the outer peripheral side toward the inner peripheral side in the thickness direction of the ring body 23 (to the left in the figure) while being rotated, so that the concave arc-shaped portion 42a is pressed against the outer peripheral side of the one lateral end (the outer peripheral side of the end) of the ring body 23. The outer peripheral side of the end of the ring body 23 is thus formed into a round shape (see FIGS. 5B, 5C). At the same time, the inner peripheral-side polishing roll 46 is moved from the inner peripheral side toward the outer peripheral side in the thickness direction of the ring body 23 (to the right in the figure) while being rotated, so that the concave arc-shaped portion 47a is pressed against the inner peripheral side of the one lateral end (the inner peripheral side of the end) of the ring body 23. The inner peripheral side of the end of the ring body 23 is thus formed into a round shape (see FIGS. 6B, 6C). The outer peripheral side and the inner peripheral side of the end of the ring body 23 need not necessarily be processed at the same time, but may be processed at different timings. That is, the inner peripheral side of the end of the ring body 23 may be processed after the outer peripheral side of the end is processed, or the outer peripheral side of the end of the ring body 23 may be processed after the inner peripheral side of the end is processed. The rotational direction of the outer peripheral-side polishing roll 41 and the inner peripheral-side polishing roll 46 at the contact point with the ring body 23 may be either the same as or opposite to the turning direction of the ring body 23. After the one lateral end of the ring body 23 is thus polished, the ring body 23 is removed from the rotating unit 31 and is mounted again on the rotating unit 31 with its one lateral end and the other lateral end switched, and the other lateral end of the ring body 23 is similarly polished. The heat-affected zones are thus removed from both lateral ends of the ring body 23, and both lateral ends of the ring body 23 are formed into a semicircular shape with almost no edge. The pair of the outer peripheral-side polishing unit 40 and the inner peripheral-side polishing unit 45 may be provided for each of the one lateral end and the other lateral end of the ring body 23 so that each of the one lateral end and the other lateral end of the ring body 23 is polished by a corresponding pair of the outer peripheral-side polishing unit 40 and the inner peripheral-side polishing unit 45.

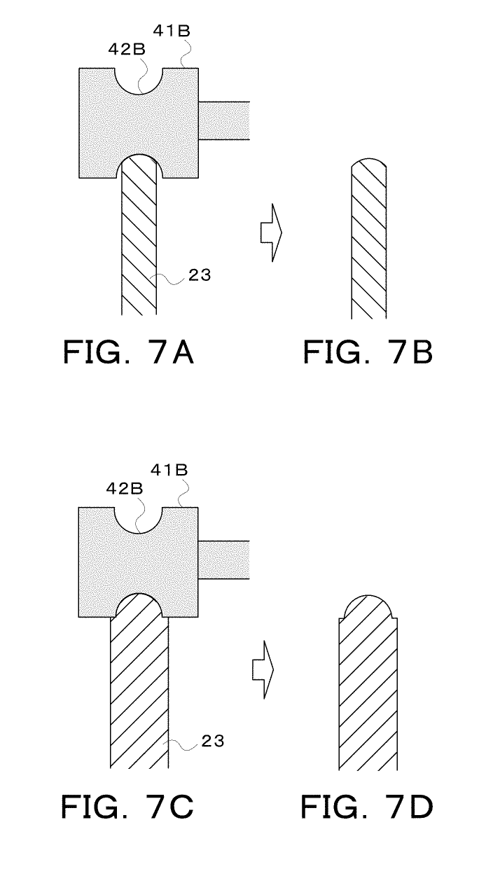

FIGS. 7A to 7D are illustrations showing how a lateral end of the ring body 23 is rounded by using a polishing roll 41B of a comparative example. The polishing roll 41B of the comparative example has a semicircular groove 42B formed in the middle of its outer peripheral surface in the axial direction along the entire circumference, and the semicircular groove 42B has an arc angle θ of about 180 degrees and a radius of curvature r that is about ½ of the thickness t of the ring body 23. In the comparative example, the polishing roll 41B is moved in the lateral direction of the ring body 23 while being rotated, so that the groove 42B of the polishing roll 41B is pressed against the end face of the lateral end of the ring body 23. The lateral end of the ring body 23 is thus polished and formed into a round shape. In the case where the ring body 23 is rounded by using the polishing roll 41B of this modification, the lateral end of the ring body 23 can be formed into a semicircular shape with almost no edge if the thickness t of the ring body 23 satisfies the relationship t=2·r for the radius of curvature r of the groove 42B. However, there is actually a variation in thickness of the ring bodies 23. If the thickness t of the ring body 23 is t<2·r, edges may remain in both ends in the thickness direction of the end face of the ring body 23 (see FIGS. 7A, 7B). If the thickness t of the ring body 23 is t>2·r, both ends of the end face of the ring body 23 in the thickness direction may be polished by the outer peripheral surface of the polishing roll 41B other than the groove 42B, which may cause undercuts (see FIGS. 7C, 7D). In the present embodiment, the polishing roll is divided into the outer peripheral-side polishing roll 41 and the inner peripheral-side polishing roll 46, and the outer peripheral side and the inner peripheral side of each lateral end of the ring body 23 are polished into a round shape by the outer peripheral-side polishing roll 41 and the inner peripheral-side polishing roll 46. This allows both lateral ends of the ring body 23 to be formed into a semicircular shape with almost no edge regardless of the variation in thickness of the ring bodies 23.

The pre-rolling cleaning process (H) is a process of, before rolling the ring body 23, removing polishing debris etc. that has stuck to the ring body 23 in the rounding process. The rolling process (I) is a process of rolling the ring body 23 to a required thickness with a rolling roller to produce a ring body 24. As described above, in the case where a laser cutting machine is used in the ring cutting process (F), the heat-affected zones with high hardness are removed from the ring body 23 by the rounding process (G) after the ring cutting process (F). The ring body 23 can therefore be rolled to a desired thickness by the rolling process (I) without breakage. The post-rolling cleaning process (J) is a process of removing rolling oil etc. that has stuck to the ring body 24 by the rolling. The second solution treatment process (K) is a process of heating the ring body 24 produced by the rolling to recrystallize a metallic structure transformed by the rolling.

The circumference adjusting process (L) is a process of finely adjusting the circumferences of a plurality of the ring bodies 24 produced by the rolling so that the ring bodies 24 can be laminated in the radial direction. The aging and nitriding process (M) is a process of aging the ring bodies 24 with the adjusted circumferences and then nitriding the ring bodies 24 to strengthen the surfaces of the ring bodies 24.

According to the embodiment described above, the ring body 23 under tension is rotated in the circumferential direction, and the concave arc-shaped portion 42a is pressed against a lateral end of the ring body 23 from the outer peripheral side toward the inner peripheral side in the thickness direction of the ring body 23, whereby the outer peripheral side of the lateral end of the ring body 23 is polished into a round shape. The concave arc-shaped portion 47a is also pressed against the lateral end of the ring body 23 from the inner peripheral side toward the outer peripheral side in the thickness direction of the ring body 23, whereby the inner peripheral side of the lateral end of the ring body 23 is polished into a round shape. Since the outer peripheral side and the inner peripheral side of the lateral end of the ring body 23 are thus separately polished, processing accuracy of the lateral end of the ring body 23 can further be improved even if there is a variation in thickness of the ring bodies 23.

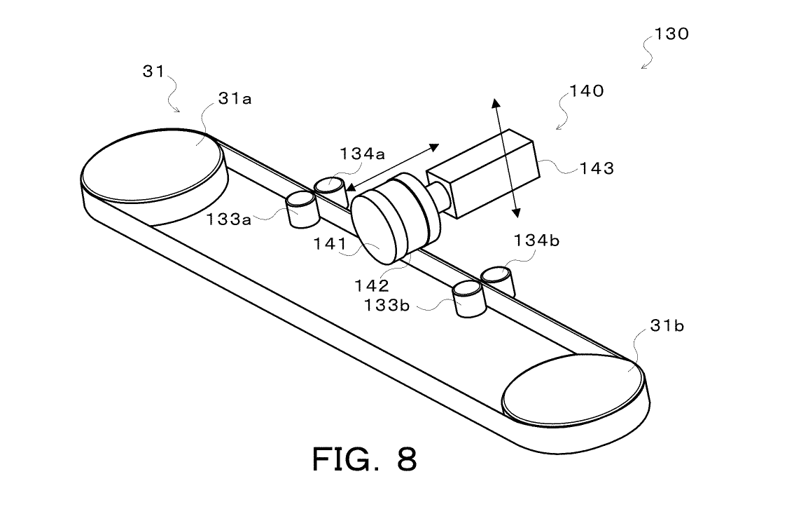

In the above embodiment, the polishing roll for the rounding process (G) is divided into the outer peripheral-side polishing roll 41 that polishes the outer peripheral side of an end of the ring body 23 and the inner peripheral-side polishing roll 46 that polishes the inner peripheral side of the end of the ring body 23. However, the outer peripheral side and the inner peripheral side of the end of the ring body 23 may be rounded by using an integrated polishing roll 141. FIG. 8 is a configuration diagram schematically showing the configuration of a polishing apparatus 130 of another embodiment. As shown in the figure, the polishing apparatus 130 of the another embodiment includes: a rotating unit 31 having a drive roller 31a and a driven roller 31b; a polishing unit 140 that rounds the outer peripheral side and the inner peripheral side of an end of the ring body 23; inner peripheral-side backup rollers 133a, 133b that are disposed in front of and behind the polishing unit 140 in a direction in which the ring body 23 is fed and support the ring body 23 from the inner peripheral side; and outer peripheral-side backup rollers 134a, 134b that are disposed in front of and behind the polishing unit 140 in the direction in which the ring body 23 is fed and support the ring body 23 from the outer peripheral side. The polishing unit 140 includes: a polishing roll 141 having an axis of rotation extending in a direction parallel to the thickness direction of the ring body 23 set on the rotating unit 31; and a rotating and moving unit 143 capable of rotating and moving the polishing roll 141 in the rotational direction of the polishing roll 141, the axial direction of the axis of rotation of the polishing roll 141 (forward and backward in the figure), and a direction perpendicular to this axial direction and parallel to the lateral direction of the ring body 23 (upward and downward in the figure).

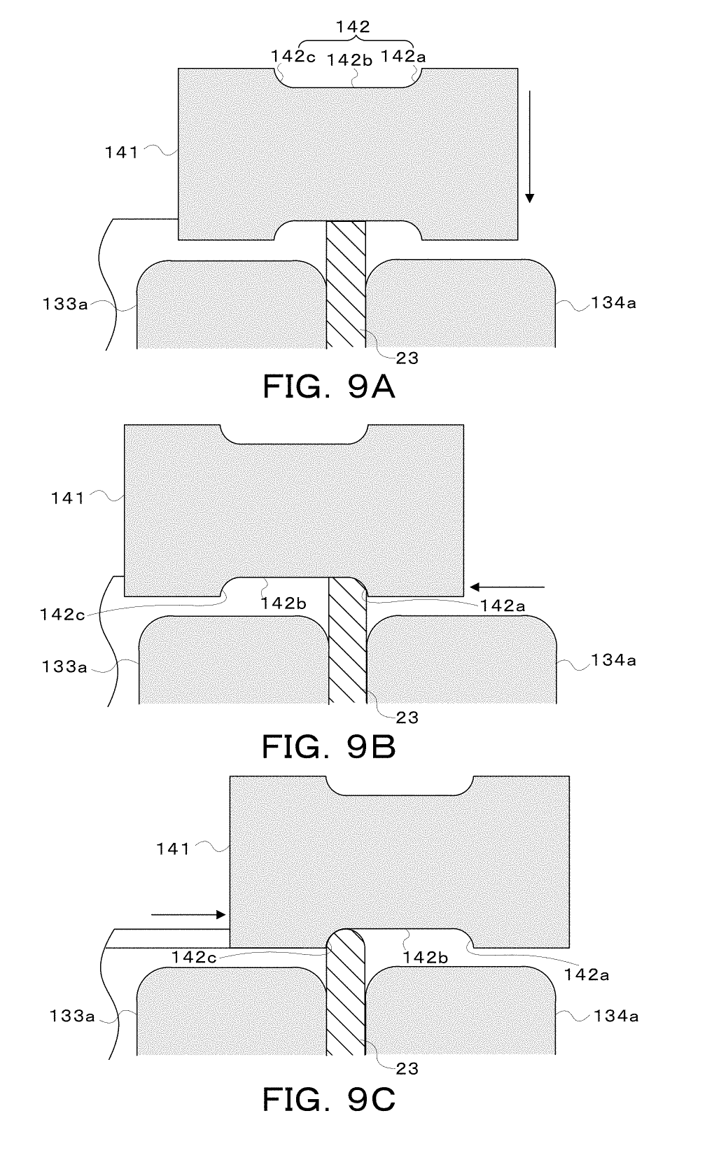

FIGS. 9A to 9C are illustrations showing how a lateral end of the ring body 23 is rounded by using the polishing roll 141. In FIG. 9, a groove 142 of the polishing roll 141 is shown exaggerated for convenience of description. The polishing roll 141 is a columnar member and has the groove 142 formed in the circumferential direction in the middle of its outer peripheral surface in the axial direction along the entire circumference. The bottom of the groove 142 is formed by a linear portion 142b extending straight in the axial direction of the roll and both corners of the bottom of the groove 142 are formed by concave arc-shaped portions 142a, 142c having an arc angle θ of about 90 degrees and a radius of curvature r that is about ½ of the thickness t of the ring body 23. The groove 142 has an abrasive grain layer comprised of abrasive grains bonded together. The ring body 23 is rounded by using the polishing roll 141 as follows. First, the polishing roll 141 is moved in the lateral direction of the ring body 23 (downward in the figure) while being rotated, so that the linear portion 142b is pressed against the end face of one lateral end of the ring body 23 (see FIG. 9A). The polishing roll 141 is then moved from the outer peripheral side toward the inner peripheral side in the thickness direction of the ring body 23 (to the left in the figure) while being rotated, so that the concave arc-shaped portion 142a is pressed against the outer peripheral side of the one lateral end (the outer peripheral side of the end) of the ring body 23. The outer peripheral side of the end of the ring body 23 is thus formed into a round shape (see FIG. 9B). The polishing roll 141 is then moved from the inner peripheral side toward the outer peripheral side in the thickness direction of the ring body 23 (to the right in the figure) while being rotated, so that the concave arc-shaped portion 142c is pressed against the inner peripheral side of the lateral end (the inner peripheral side of the end) of the ring body 23. The inner peripheral side of the end of the ring body 23 is thus formed into a round shape (see FIG. 9C). After the one lateral end of the ring body 23 is thus polished, the ring body 23 is removed from the rotating unit 31 and is mounted again on the rotating unit 31 with its one lateral end and the other lateral end switched, and the other lateral end of the ring body 23 is similarly polished. Heat-affected zones are thus removed from both lateral ends of the ring body 23, and both lateral ends of the ring body 23 are formed into a semicircular shape with almost no edge. The polishing unit 140 may be provided for each of the one lateral end and the other lateral end of the ring body 23 so that each of the one lateral end and the other lateral end of the ring body 23 is polished by a corresponding one of the polishing units 140. In this another embodiment, the inner peripheral side of the end of the ring body 23 is processed after the outer peripheral side of the end is processed. However, the outer peripheral side of the end of the ring body 23 may be processed after the inner peripheral side of the end is processed. The outer peripheral side and the inner peripheral side of the end of the ring body 23 may be alternately processed little by little by repeatedly reciprocating the polishing roll 141 in the axial direction.

As described above, a method for manufacturing a ring according to the present disclosure is a method for manufacturing an endless metal ring (23) for a continuously variable transmission (1) using a transmission belt (10) that is formed by binding a plurality of elements (11) with the ring (12, 20, 23). In the method, after a tubular body (22) formed by butt welding ends of a strip is cut into a plurality of ring bodies (23), the ring body (23) being under tension is rotated in a circumferential direction, and a grinding wheel (42a, 142a) is pressed against a lateral end of the ring body (23) from an outer peripheral side toward an inner peripheral side in a thickness direction of the ring body (23) to remove an edge portion which is on the outer peripheral side of the lateral end of the ring body (23) and has been formed by the cutting, and the grinding wheel (47a, 142b) is pressed against the lateral end of the ring body (23) from the inner peripheral side toward the outer peripheral side in the thickness direction of the ring body (23) to remove an edge portion which is on the inner peripheral side of the lateral end of the ring body (23) and has been formed by the cutting.

In the method for manufacturing a ring according to the present disclosure, after a tubular body (22) formed by butt welding ends of a strip is cut into a plurality of ring bodies (23), the ring body (23) being under tension is rotated in the circumferential direction, and the grinding wheel (42a, 142a) is pressed against a lateral end of the ring body (23) from the outer peripheral side toward the inner peripheral side to remove an edge portion which is on the outer peripheral side of the lateral end of the ring body (23) and has been formed by the cutting, and the grinding wheel (47a, 142b) is pressed against the lateral end of the ring body (23) from the inner peripheral side toward the outer peripheral side to remove an edge portion which is on the inner peripheral side of the lateral end of the ring body (23) and has been formed by the cutting. Accordingly, as compared to the case where a semicircular groove is pressed against a lateral end of a ring body in a lateral direction of the ring body to process edge portions, processing accuracy of the lateral end of the ring body (23) can further be improved even if there is a variation in thickness of the ring bodies.

In the method for manufacturing a ring according to the present disclosure, a part of the grinding wheel (42a, 142a, 47a, 142b) which removes the edge portion may have a concave arc shape so as to polish the outer peripheral side or the inner peripheral side of the lateral end of the ring body (23) into a round shape. This allows the edge portion of the ring body which has been formed by the cutting to be processed into a smooth round shape.

A first ring polishing apparatus according to the present disclosure is a ring (23) polishing apparatus (30) for polishing into a round shape a lateral end of an endless metal ring (23) for a continuously variable transmission (1) using a transmission belt (10) that is formed by binding elements (11) with the ring (12, 20, 23). The apparatus includes: a rotating unit (31) that has a first roller (31a) and a second roller (31b) and that rotates the ring (23) wound around the first roller (31a) and the second roller (31b) and under tension in a circumferential direction; a first polishing unit (40) that has a concave arc-shaped first polishing portion (42a) and that presses the first polishing portion (42a) against the lateral end of the ring (23) from an outer peripheral side toward an inner peripheral side in a thickness direction of the ring (23) to polish the outer peripheral side of the lateral end of the ring (23) into a round shape; and a second polishing unit (45) that has a concave arc-shaped second polishing portion (47a) and that presses the second polishing portion (47a) against the lateral end of the ring (23) from the inner peripheral side toward the outer peripheral side in the thickness direction of the ring (23) to polish the inner peripheral side of the lateral end of the ring (23) into a round shape.

In the first ring polishing apparatus according to the present disclosure, a polishing unit for polishing a lateral end of the ring (23) into a round shape is divided into the first polishing unit (40) having the concave arc-shaped first polishing portion (42a) and the second polishing unit (45) having the concave arc-shaped second polishing portion (47a). The first polishing portion (42a) is pressed against the lateral end of the ring (23) from the outer peripheral side toward the inner peripheral side in the thickness direction of the ring (23) to polish the outer peripheral side of the lateral end of the ring (23) into a round shape, and the second polishing portion (47a) is pressed against the lateral end of the ring (23) from the inner peripheral side toward the outer peripheral side in the thickness direction of the ring (23) to polish the inner peripheral side of the lateral end of the ring (23) into a round shape. The outer peripheral side and the inner peripheral side of the lateral end of the ring (23) are thus separately polished. Accordingly, processing accuracy of the lateral end of the ring (23) can further be improved even if there is a variation in thickness of the rings (23).

In the first ring polishing apparatus according to the present disclosure, the first polishing unit (40) may include: a first polishing roll (41) having an L-shaped groove (42) formed in its outer peripheral surface along entire circumference and having an axis of rotation parallel to the thickness direction of the ring (23) set on the rotating unit (31), the L-shaped groove (42) having the concave arc-shaped first polishing portion (42a) in a corner of a bottom of the groove; and a first rotating and moving unit (43) that, while rotating the first polishing roll (41), moves the first polishing roll (41) in an axial direction so that the first polishing portion (42a) is pressed against the lateral end of the ring (23) from the outer peripheral side toward the inner peripheral side in the thickness direction of the ring (23), and the second polishing unit (45) may include: a second polishing roll (46) having an L-shaped groove (47) formed in its outer peripheral surface along entire circumference and having an axis of rotation parallel to the thickness direction of the ring (23) set on the rotating unit (31), the L-shaped groove (47) having the concave arc-shaped second polishing portion (47a) in a corner of a bottom of the groove; and a second rotating and moving unit (48) that, while rotating the second polishing roll (46), moves the second polishing roll (46) in an axial direction so that the second polishing portion (47a) is pressed against the lateral end of the ring (23) from the inner peripheral side toward the outer peripheral side in the thickness direction of the ring (23). The outer peripheral side and the inner peripheral side of the lateral end of the ring (23) can thus be processed at the same time by moving the first polishing roll (41) in the axial direction by the first rotating and moving unit (43) and moving the second polishing roll (46) in the axial direction by the second rotating and moving unit (48).

A second ring polishing apparatus according to the present disclosure is a ring (23) polishing apparatus (130) for polishing into a round shape a lateral end of an endless metal ring (23) for a continuously variable transmission (1) using a transmission belt (10) that is formed by binding elements (11) with the ring (12, 20, 23). The apparatus includes: a rotating unit (31) that has a first roller (31a) and a second roller (31b) and that rotates the ring (23) wound around the first roller (31a) and the second roller (31b) and under tension in a circumferential direction; and a polishing unit (140) that has a concave arc-shaped first polishing portion (142a) and a concave arc-shaped second polishing portion (142c) which are formed next to each other in a thickness direction of the ring (23) so that the ring (23) set on the rotating unit (31) is located between the first polishing portion (142a) and the second polishing portion (142c), and that presses the first polishing portion (142a) against the lateral end of the ring (23) from an outer peripheral side toward an inner peripheral side in the thickness direction of the ring (23) to polish the outer peripheral side of the lateral end of the ring (23) into a round shape, and presses the second polishing portion (142c) against the lateral end of the ring (23) from the inner peripheral side toward the outer peripheral side in the thickness direction of the ring (23) to polish the inner peripheral side of the lateral end of the ring (23) into a round shape.

In the second ring polishing apparatus according to the present disclosure, a polishing unit for polishing a lateral end of the ring (23) into a round shape is the polishing unit (140) having the concave arc-shaped first polishing portion (142a) and the concave arc-shaped second polishing portion (142c) which are formed next to each other in the thickness direction of the ring (23) so that the ring (23) set on the rotating unit (31) is located between the first polishing portion (142a) and the second polishing portion (142c). The first polishing portion (142a) is pressed against the lateral end of the ring (23) from the outer peripheral side toward the inner peripheral side in the thickness direction of the ring (23) to polish the outer peripheral side of the lateral end of the ring (23) into a round shape, and the second polishing portion (142c) is pressed against the lateral end of the ring (23) from the inner peripheral side toward the outer peripheral side in the thickness direction of the ring (23) to polish the inner peripheral side of the lateral end of the ring (23) into a round shape. The outer peripheral side and the inner peripheral side of the lateral end of the ring (23) are thus separately polished. Accordingly, processing accuracy of the lateral end of the ring (23) can further be improved even if there is a variation in thickness of the rings (23). Moreover, since the outer peripheral side and the inner peripheral side of the lateral end of the ring (23) can be separately polished by the single polishing unit (140), processing accuracy of the ring (23) can be improved by using a simple configuration.

In the second ring polishing apparatus according to the present disclosure, the polishing unit (140) may include: a polishing roll (141) having a groove (142) formed in its outer peripheral surface along entire circumference and having an axis of rotation parallel to the thickness direction of the ring (23), the groove (142) including the concave arc-shaped first polishing portion (142a) and the concave arc-shaped second polishing portion (142c) which are formed in both corners of a bottom of the groove and a linear portion (142b) serving as the bottom and connecting arc ends of the first polishing portion (142a) and the second polishing portion (142c); and a rotating and moving unit (143) that, while rotating the polishing roll (141), moves the polishing roll (141) toward one side in an axial direction so that the first polishing portion (142a) is pressed against the lateral end of the ring (23) from the outer peripheral side toward the inner peripheral side in the thickness direction of the ring (23), and moves the polishing roll (142) toward the other side in the axial direction so that the second polishing portion (142c) is pressed against the lateral end of the ring (23) from the inner peripheral side toward the outer peripheral side in the thickness direction of the ring (23). The outer peripheral side and the inner peripheral side of the lateral end of the ring (23) can thus be separately processed by the single polishing unit (140) by reciprocating the polishing roll (141) in the axial direction.

Although the embodiments of the invention of the present disclosure are described above, it is to be understood that the invention of the present disclosure is not limited in any way to the above embodiments and may be carried out in various forms without departing from the spirit and scope of the invention of the present disclosure.

### INDUSTRIAL APPLICABILITY

The invention of the present disclosure can be utilized in manufacturing industries of transmission belts for use in continuously variable transmissions.

1. A method for manufacturing an endless metal ring for a continuously variable transmission using a transmission belt that is formed by binding a plurality of elements with the ring, wherein
after a tubular body formed by butt welding ends of a strip is cut into a plurality of ring bodies, the ring body being under tension is rotated in a circumferential direction, and a grinding wheel is pressed against a lateral end of the ring body from an outer peripheral side toward an inner peripheral side in a thickness direction of the ring body to remove an edge portion which is on the outer peripheral side of the lateral end of the ring body and has been formed by the cutting, and a grinding wheel is pressed against the lateral end of the ring body from the inner peripheral side toward the outer peripheral side in the thickness direction of the ring body to remove an edge portion which is on the inner peripheral side of the lateral end of the ring body and has been formed by the cutting.

2. The method for manufacturing a ring according to claim 1, wherein
a part of the grinding wheel which removes the edge portion has a concave arc shape so as to polish the outer peripheral side or the inner peripheral side of the lateral end of the ring body into a convex arc shape.

3. A ring polishing apparatus for polishing into a convex arc shape a lateral end of an endless metal ring for a continuously variable transmission using a transmission belt that is formed by binding elements with the ring, comprising:
a rotating unit that has a first roller and a second roller and that rotates the ring wound around the first roller and the second roller and under tension in a circumferential direction;
a first polishing unit that has a concave arc-shaped first polishing portion and that presses the first polishing portion against the lateral end of the ring from an outer peripheral side toward an inner peripheral side in a thickness direction of the ring to polish the outer peripheral side of the lateral end of the ring into a convex arc shape; and
a second polishing unit that has a concave arc-shaped second polishing portion and that presses the second polishing portion against the lateral end of the ring from the inner peripheral side toward the outer peripheral side in the thickness direction of the ring to polish the inner peripheral side of the lateral end of the ring into a convex arc shape.

4. The ring polishing apparatus according to claim 3, wherein
the first polishing unit includes: a first polishing roll having an L-shaped groove formed in its outer peripheral surface along entire circumference and having an axis of rotation parallel to the thickness direction of the ring set on the rotating unit, the L-shaped groove having the concave arc-shaped first polishing portion in a corner of a bottom of the groove; and a first rotating and moving unit that, while rotating the first polishing roll, moves the first polishing roll in an axial direction so that the first polishing portion is pressed against the lateral end of the ring from the outer peripheral side toward the inner peripheral side in the thickness direction of the ring, and
the second polishing unit includes: a second polishing roll having an L-shaped groove formed in its outer peripheral surface along entire circumference and having an axis of rotation parallel to the thickness direction of the ring set on the rotating unit, the L-shaped groove having the concave arc-shaped second polishing portion in a corner of a bottom the groove; and a second rotating and moving unit that, while rotating the second polishing roll, moves the second polishing roll in an axial direction so that the second polishing portion is pressed against the lateral end of the ring from the inner peripheral side toward the outer peripheral side in the thickness direction of the ring.

5. A ring polishing apparatus for polishing into a convex arc shape a lateral end of an endless metal ring for a continuously variable transmission using a transmission belt that is formed by binding elements with the ring, comprising:
a rotating unit that has a first roller and a second roller and that rotates the ring wound around the first roller and the second roller and under tension in a circumferential direction; and
a polishing unit that has a concave arc-shaped first polishing portion and a concave arc-shaped second polishing portion which are formed next to each other in a thickness direction of the ring so that the ring set on the rotating unit is located between the first polishing portion and the second polishing portion, and that presses the first polishing portion against the lateral end of the ring from an outer peripheral side toward an inner peripheral side in the thickness direction of the ring to polish the outer peripheral side of the lateral end of the ring into a convex arc shape, and presses the second polishing portion against the lateral end of the ring from the inner peripheral side toward the outer peripheral side in the thickness direction of the ring to polish the inner peripheral side of the lateral end of the ring into a convex arc shape.

6. The ring polishing apparatus according to claim 5, wherein
the polishing unit includes
a polishing roll having a groove formed in its outer peripheral surface along entire circumference and having an axis of rotation parallel to the thickness direction of the ring, the groove including the concave arc-shaped first polishing portion and the concave arc-shaped second polishing portion which are formed in both corners of a bottom of the groove and a linear portion serving as the bottom and connecting arc ends of the first polishing portion and the second polishing portion, and
a rotating and moving unit that, while rotating the polishing roll, moves the polishing roll toward one side in an axial direction so that the first polishing portion is pressed against the lateral end of the ring from the outer peripheral side toward the inner peripheral side in the thickness direction of the ring, and moves the polishing roll toward the other side in the axial direction so that the second polishing portion is pressed against the lateral end of the ring from the inner peripheral side toward the outer peripheral side in the thickness direction of the ring.
